(19) United States
(12) Patent Application Publication
(10) Pub. No.: US 2017/0047870 A1
(43) Pub. Date: Feb. 16, 2017

(54) MAGNETIC-CONTROLLED GENERATOR WITH BUILT-IN CONTROLLER

(71) Applicant: CHI HUA FITNESS CO., LTD., HSINCHU COUNTY (TW)

(72) Inventor: YING-CHE LEE, HSINCHU COUNTY (TW)

(21) Appl. No.: 14/825,282

(22) Filed: Aug. 13, 2015

(51) Int. Cl. H02P 3/14; H02K 1/06; A63B 21/00; H02K 7/02

(52) U.S. Cl. CPC H02P 3/14; H02K 7/02; H02K 1/06; A63B 21/00192

(57) ABSTRACT

Disclosed is a magnetic-controlled generator with built-in controller that has integrated design of power generator with magnetic resistance and control circuit unit. The built-in control circuit unit is electrically connected to an armature core, an external digital operator, and a magnetic coil, in order to convert AC power produced by the armature core into DC power to supply for the magnetic coil and meanwhile control the resistance of a flywheel by inserting a number of torque value to the external digital operator. In application to training machines, the device is easy to be installed and operated without restrictions in extra spaces for a controller and configuration of wires.

### BACKGROUND OF THE INVENTION

1. Field of the Invention

The present invention relates to a magnetic-controlled generator, particularly to one that is applied to training machines with a built-in control unit combining a power generator with magnetic resistance.

2. Description of the Related Art

Many training machines have a flywheel to support the inertia of rotation, and the flywheel can be the loading for training. Recently, a structure of having a flywheel with a permanent magnet as a rotor and an armature as a stator is commonly applied. It has a stator coil producing AC currents for controlling and brake loading. Such structure has been disclosed in U.S. Pat. No. 6,084,325 as shown in FIGS. 1A and 1B and in U.S. Pat. No. 7,732,961 as shown in FIG. 2.

In FIGS. 1A and 1B, a flywheel 820 is rotated by a rotary wheel A. A permanent magnet 821 is fitted in the flywheel 820 to form a magnetic field with a stator core 830 to produce currents supplied for a display & control gauge 890 and a brake core 850 arranged aside the flywheel 820 after conversion. The brake core 850 consequently has eddy current against the flywheel 820. The application principle in the structure of FIG. 2 is similar to the one in FIG. 1A; the only difference is that the brake core 850 in FIG. 1A is arranged on the outer edge of the flywheel 820, and the brake core 980 in FIG. 2 is on the inner edge of the flywheel 820.

The structures disclosed above can produce electricity power by the force from operators to form magnetic resistance as a loading for training, which has excellent training function. However, the structures produce high power of electricity with large magnetic resistance and are therefore suitable for large devices only. It would not be a good choice for small devices. The inventor thus tries to find a structure that would reduce the loading, the volume, and the manufacturing costs; in other words, that is suitable for small devices.

Further referring to FIGS. 1B and 2, a controller of the device includes a commutating & wave filtering circuit and an adjustable DC power supply. The commutating & wave filtering circuit converts AC currents produced by a power generator into DC currents, and the controller calculates the torque value entered via a display & control gauge 890 to control the currents supplied from the DC power supply, resulting in the brake core 850, 980 forming eddy current against the flywheel 820. The controller used to connect from the outside via circuit modules; therefore the training machines would not have a space designed for the controller, and there are problems of configuration of wires during installation.

### SUMMARY OF THE INVENTION

A primary object of the present invention is to provide a magnetic-controlled generator with built-in controller that generates electricity power and has a magnetic resistance loading device, making it suitable for small training machines with small volume and low costs in manufacturing.

Another object of the present invention is to provide a magnetic-controlled generator with built-in controller that integrates a controller and a power generator with magnetic resistance, so as to remove the difficulties of installation of the controller and configuration of the wires.

To achieve the objects mentioned above, the present invention comprises a shaft having a middle section and two engaging ends to fixedly engage a supporting seat of a training machine; a transmission element to be engaged either of the engaging ends of the shaft for receiving the driving force from the training machine; the transmission element being a pulley in this embodiment; an outer rotor including a flywheel and a permanent magnet; the flywheel having an outer rim and an inner rim sharing the same axis to form a first annular space and a second annular space, and engaging the shaft to be driven and rotate by the transmission element; the permanent magnet being fixedly arranged along the inner peripheral edge of the inner rim; an inner stator including a coil holder mounted on the shaft and an armature core assembled along the edge of the coil holder for the inner stator to be disposed in the first annular space; the outer edge of the armature core being arranged next to the inner edge of the permanent magnetic; whereby the rotation of the outer rotor would produce AC currents by the inner stator and the currents would be output by an output wire connected to the outside of the armature core: a reluctance device including a stator core having two corresponding indentation spaces to engage a magnetic coil, and an input wire connected to the magnetic coil; an engaging element being fixedly engaged the coil holder and having the stator core assembled thereon for the reluctance device to be disposed in the second annular space; a magnetic ring being arranged—in this embodiment, being directly formed—along the inner peripheral edge of the outer rim of the flywheel and having a gap between the outer edge of the stator core and the inner edge of the magnetic ring; when DC currents being input via the input wire of the magnetic coil, the stator core would produce a magnetic field and further create eddy reluctance with the coupled magnetic ring, forming internal reverse resistance against the flywheel; a control circuit unit built aside the engaging element and connected to the output wire of the armature core, an external digital operator, and the input wire of the magnetic coil, which at least includes a self-activated circuit, a AC-DC conversion circuit, a microprocessor, and a DC control circuit and is able to convert the AC currents from the armature core to DC currents for supplying the magnetic coil; the digital operator receiving a number of torque value from an operator and the microprocessor producing a controlling value for adjusting the currents input from the DC control circuit to form the reverse resistance against the flywheel.

In addition, there are two reluctance devices disposed in the second annular space symmetrically; in other words, there are two stator cores engaging two magnetic coils and two input wires connected to the magnetic coils. The present invention further includes a built-in wireless transmission unit at the corresponding side of the control circuit unit, aside the engaging element, to transmit signals between the control circuit unit and the external digital operator; the wireless transmission unit includes Bluetooth device but is not limited to such application.

Also, the control circuit unit and the wireless transmission unit each has a protective piece arranged on the outside, correspondingly connecting the engaging element for protection. The microprocessor is further connected to a transmission port for software to store the torque values from the training machine into the microprocessor for the control circuit unit to operate the adjusting process.

With structures disclosed above, the present invention has a smaller volume and low costs with dual function of power generating and magnetic resistance. The design of combining the power generator, reluctance device, and the control circuit also excludes the needs of spaces for installation of the controller and configuration of the wires.

### BRIEF DESCRIPTION OF THE DRAWINGS

FIG. 1A is a side elevation view of a conventional brake device combining a power generator with eddy-current magnetic resistance;

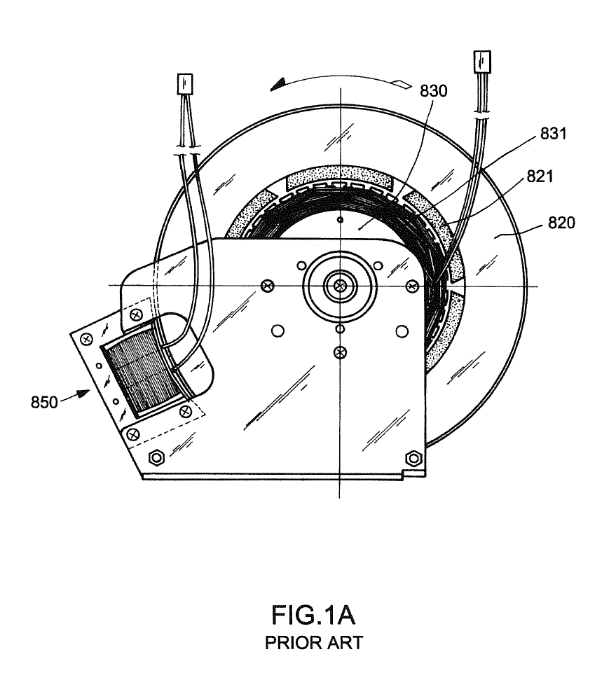

FIG. 1B is a schematic diagram illustrating the controlling structure of a conventional brake device combining a power generator with eddy-current magnetic resistance;

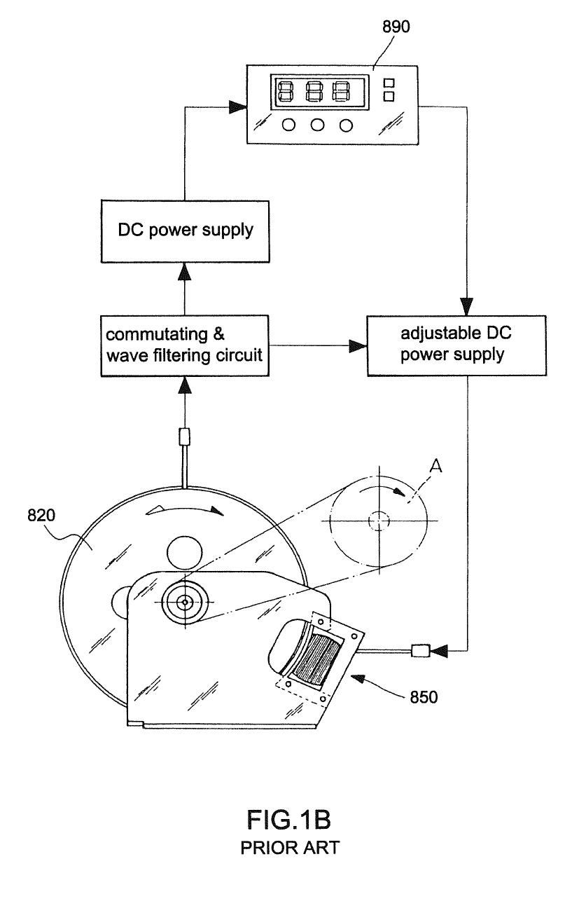

FIG. 2 is a schematic diagram of a conventional power generator with built-in eddy-current resistance;

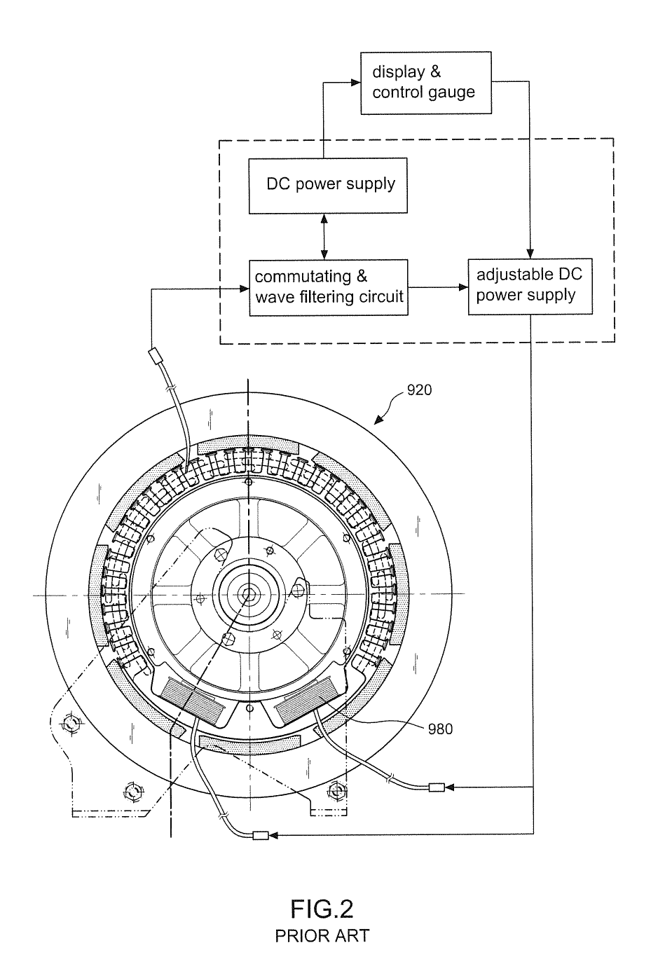

FIG. 3 is an exploded view of the present invention in a preferred embodiment;

FIG. 4 is another exploded view of the present invention in a preferred embodiment;

FIG. 5 is a perspective view of the present invention in a preferred embodiment;

FIG. 6 is a sectional view along line 6-6 in FIG. 5;

FIG. 7 is a schematic diagram illustrating the structure of a control circuit unit of the present invention; and

FIG. 8 is a schematic diagram illustrating the present invention applied to training machines.

### DETAILED DESCRIPTION OF THE PREFERRED EMBODIMENT

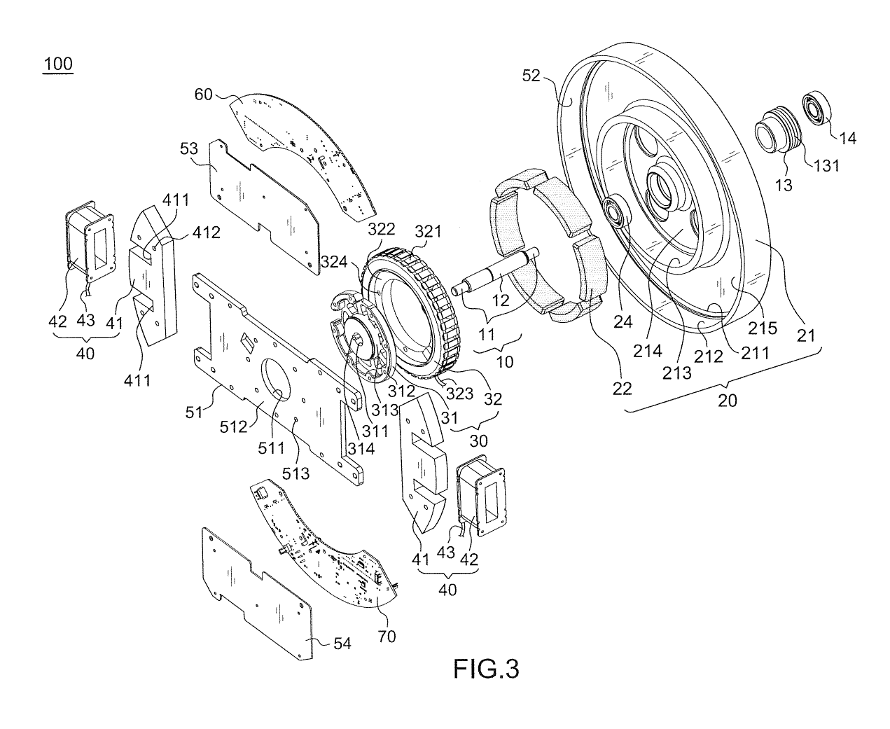

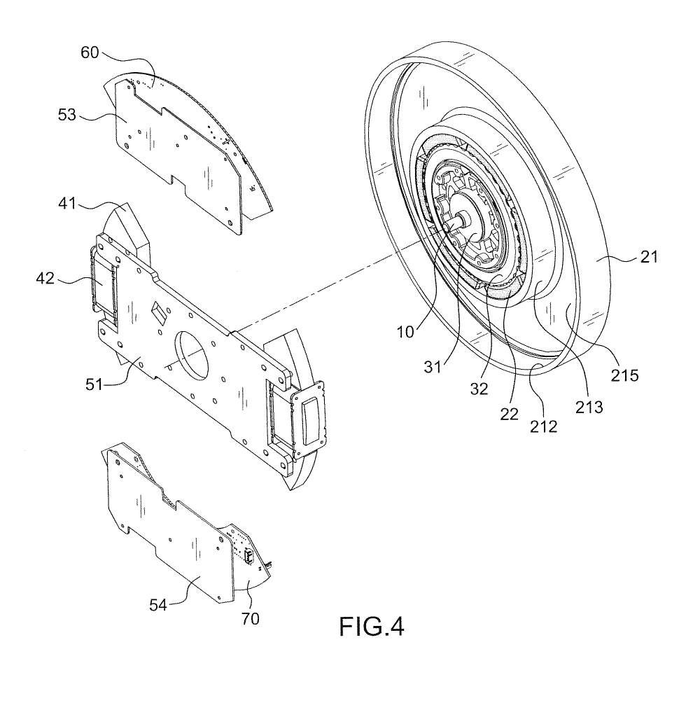

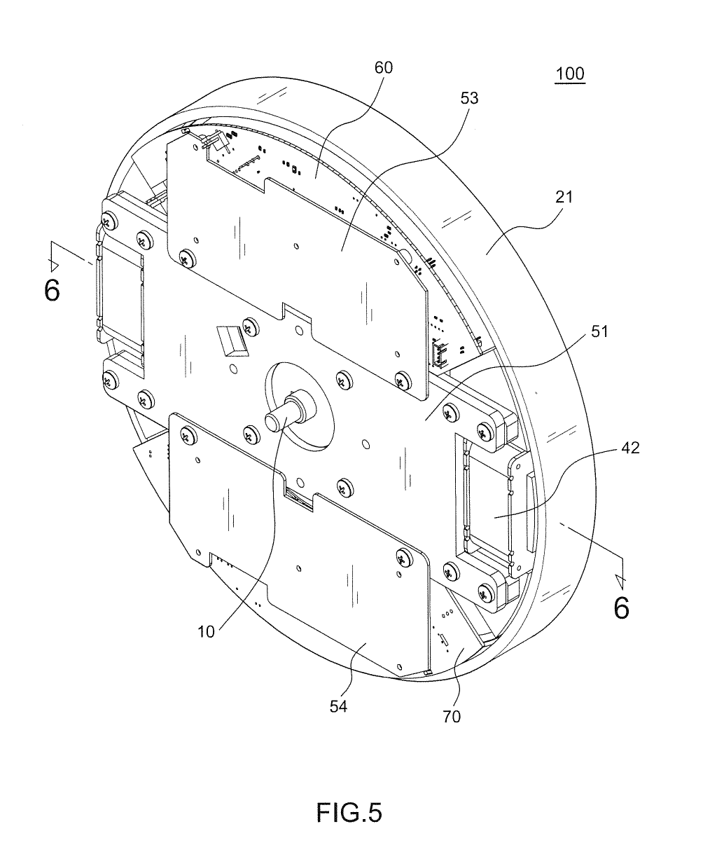

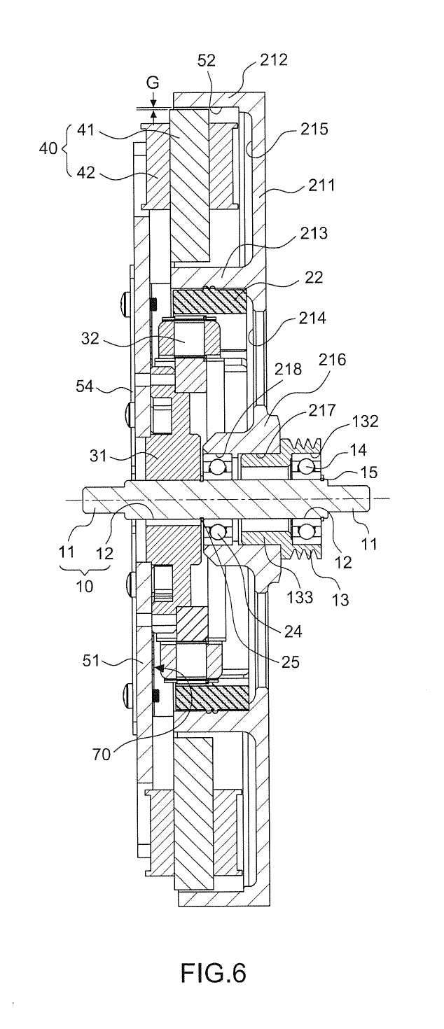

Referring to FIGS. 3-6, a preferred embodiment of the present invention mainly comprises a shaft 10, a transmission element 13, an outer rotor 20, an inner stator 30, two reluctance devices 40, an engaging element 51, a magnetic ring 52, a control circuit unit 60, and a wireless transmission unit 70.

The shaft 10 has a middle section 12 and two engaging ends 11 to be fixedly engaged a supporting seat of a training machine.

The transmission element 13 has a function of receiving the force from the training machine. In this embodiment, the transmission element 13 is a pulley, having a grooved rim 131 for a cord to engage and thus connecting to the training machine; a first bearing hole 132 is arranged for engaging a bearing 14 and being mounted on either of the engaging ends 11, and the bearing 14 is fixed by a C ring 15 so that the pulley 13 is able to rotate on the shaft 10.

The outer rotor 20 includes a flywheel 21 and a permanent magnet 22. The flywheel 21 has a plate body 211 extending outwardly to form an outer rim 212 and extending inwardly to form an inner rim 213. The outer rim 212 and the inner rim 213 are sharing the same axis to form a first annular space inside the inner rim 213 and a second annular space between the outer rim 212 and the inner rim 213. The permanent magnet is annular and arranged along the inner peripheral edge of the inner rim 213 to engage the flywheel 21. The plate body 211 further has a flange 216 including a hole 217 and a second bearing hole 218 at the center thereof. The hole 217 engages a protruding body 133 of the pulley 13 so that the outer rotor 20 is driven by the pulley 13 and simultaneously rotating therewith. The second bearing hole 218 engages a bearing 24 so that the outer rotor 20 can rotate when mounted on the shaft 10.

The inner stator 30 includes a coil holder 31 and an armature core 32. The coil holder 31 has a shaft hole 311 with a key way 314 arranged therein, a flat surface 312, and an inner flange 313. Mounted on the shaft 10 tightly and having a square key engaging the key way 314, the coil holder 31 is fixed on the shaft 10 and disposed in the first annular space 214. The armature core 32 has a power coil 321 arranged outside and connected to an output wire 323, and a core frame 322 arranged inside with a screw hole 324 thereon. The core frame 322 is fixedly screwed along the edge of the coil holder 31 for the outer edge of the power coil 321 to be arranged next to the inner edge of the permanent magnetic 22. Whereby the rotation of the outer rotor 20 would produce AC currents by the power coil 321 and the currents would be output by the output wire 323.

Each of the reluctance devices 40 includes a stator core 41 having two corresponding indentation spaces 411 to engage a magnetic coil 42, and an input wire 43 connected to the magnetic coil 42.

The engaging element 51 has an engaging hole 511 for the inner flange 313 of the coil holder 31 to be mounted thereon, and a surface 513 with a plurality of screw hole 513 to fixedly screw the coil holder 31 thereon.

The magnetic ring 52 is arranged along the inner peripheral edge of the outer rim 212 of the flywheel 21. In this embodiment, the magnetic ring 52 is directly formed on the inner peripheral edge of the outer rim 212 of the flywheel 21. The stator cores 41 have a plurality of screw holes 412 to be fixedly screwed on both sides of the engaging element 51 symmetrically so that the reluctance devices 40 are disposed in the second annular spaces 215 of the flywheel 21. The stator core 41 further has a gap G between the outer edge thereof and the inner edge of the magnetic ring 52; when DC currents are input via the input wire 43 of the magnetic coil 42, the stator core 41 would produce a magnetic field and further create eddy reluctance with coupled magnetic ring 52, forming internal reverse resistance against the flywheel 21.

The control circuit unit 60 is built aside the engaging element 51 and covered by a first protective piece 53 screwed aside the engaging element 51. The wireless transmission unit 70 transmits signals between the control circuit unit 60 and an external digital operator (not shown); the wireless transmission unit 70 is a Bluetooth device in the embodiment, but is not limited to such application. Additionally, it is built aside the engaging element 51 corresponding to the control circuit unit 60 and covered by a second protective piece 54. The protective pieces are not only elements for position fixing, but providing protection for the devices they are covering.

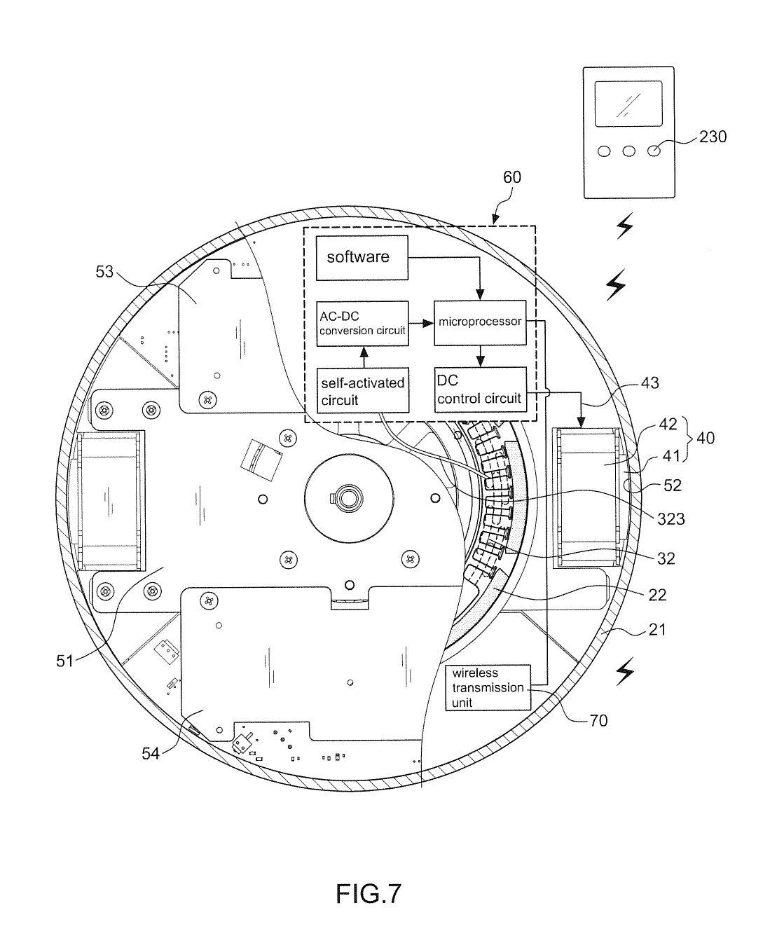

Referring to FIG. 7, the control circuit unit 60 includes a self-activated circuit 61, an AC-DC conversion circuit 62, a microprocessor 63, and a DC control circuit 64. The self-activated circuit 61 receives AC currents from the armature core 32 via the output wire 323, and the AC-DC conversion circuit 62 converts the AC currents into stable DC currents, so that when the digital operator 230 receives a number of torque value from an operator, the microprocessor 63 would produce a controlling value for the DC control circuit 64 to adjust the DC currents input to the magnetic coil 42, so as to form a reverse resistance against the flywheel 21.

In the embodiment, the microprocessor 63 is further connected to a transmission port for software to store the torque values from the training machine into the microprocessor 63 for the control circuit unit 60 to control the DC currents from the DC control circuit 64 for operation.

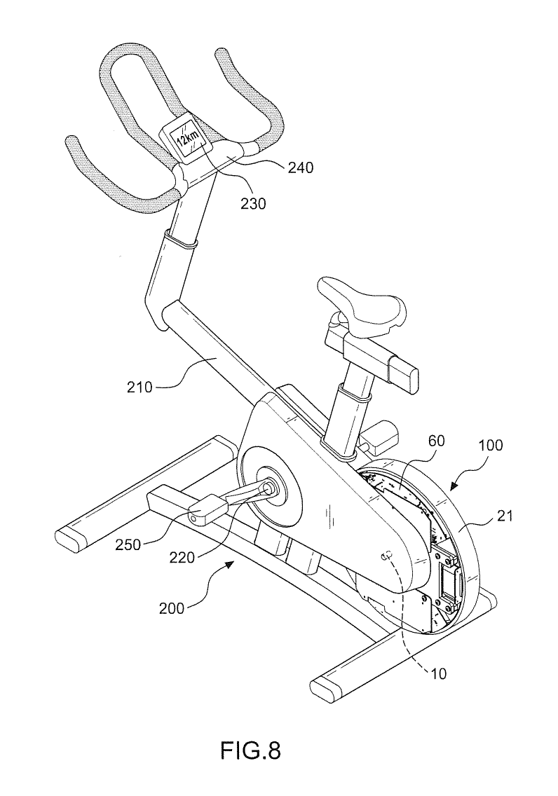

FIG. 8 is a schematic diagram illustrating the present invention—a magnetic-controlled generator with built-in controller—100 in application to a training machine 200. The magnetic-controlled generator with built-in controller 100 has the shaft 10 fixedly engaged a supporting seat of the framework 210 of the training machine 200. The training machine 200 has a pedal shaft 220 connecting the pulley 13 by a cord, and a digital operator 230 arranged on a handle 240 of the training machine 200. When the operator enters a number of torque value and runs the pedal 250 to rotate the pedal shaft 220. the armature core 32 would produce AC currents for the AC-DC conversion circuit 62 to produce DC currents and the microprocessor 63 would calculate the torque value for the DC control circuit 64 to output appropriate currents.

Then the reluctance device 40 and the magnetic ring 52 would form a reverse resistance against the flywheel 21 for the training machine 200, achieving the purpose of training.

With the structure disclosed above, the present invention provides a device with dual function of power generation and reluctance that has small volume and low costs in manufacturing. Also, the integrated design of power generator with magnetic resistance and control circuit unit excludes the needs of spaces designed for installation of the controller and configuration of the wires.

Although particular embodiments of the invention have been described in detail for purposes of illustration, various modifications and enhancements may be made without departing from the spirit and scope of the invention. Accordingly, the invention is not to be limited except by the appended claims.

What is claimed is:

1. A magnetic-controlled generator with built-in controller to be applied to training machines, comprising:
a shaft fixedly engaging a supporting seat of a training machine;
a transmission element to engage an end of the shaft for receiving the driving force from the training machine;
an outer rotor including a flywheel and a permanent magnet; the flywheel having an outer rim and an inner rim sharing the same axis to form a first annular space and a second annular space, and engaging the shaft to be driven and rotate by the transmission element; the permanent magnet being fixedly arranged along inner peripheral edge of the inner rim;
an inner stator including a coil holder mounted on the shaft and an armature core assembled along the edge of the coil holder for the inner stator to be disposed in the first annular space; the outer edge of the armature core being arranged next to the inner edge of the permanent magnet; whereby the rotation of the outer rotor would produce AC currents by the inner stator and the currents would be output by an output wire connected to the outside of the armature core;
a reluctance device including a stator core having two corresponding indentation spaces to engage a magnetic coil, and an input wire connected to the magnetic coil;
an engaging element being fixedly engaging the coil holder and having the stator core assembled thereon for the reluctance device to be disposed in the second annular space;
a magnetic ring being arranged along the inner peripheral edge of the outer rim of the flywheel and having a gap between the outer edge of the stator core and the inner edge of the magnetic ring; when DC currents being input via the input wire of the magnetic coil, the stator core would produce a magnetic field and further create eddy reluctance with the coupled magnetic ring, forming internal reverse resistance against the flywheel; and
a control circuit unit built aside the engaging element and connected to the output wire of the armature core, an external digital operator, and the input wire of the magnetic coil, which at least includes a self-activated circuit, a AC-DC conversion circuit, a microprocessor, and a DC control circuit, and is able to convert AC currents from the armature core to DC currents to supply for the magnetic coil; the digital operator receiving a number of torque value from an operator and the microprocessor producing a controlling value for adjusting the currents input from the DC control circuit to form the reverse resistance against the flywheel.

2. The magnetic-controlled generator with built-in controller as claimed in claim 1, wherein there are two reluctance devices disposed in the second annular space symmetrically.

3. The magnetic-controlled generator with built-in controller as claimed in claim 1, wherein the transmission element is a pulley.

4. The magnetic-controlled generator with built-in controller as claimed in claim 1, wherein the present invention further includes a wireless transmission unit arranged at the corresponding side of the control circuit unit aside the engaging element for signal transmission between the control circuit unit and the external digital operator.

5. The magnetic-controlled generator with built-in controller as claimed in claim 4, wherein the control circuit unit and the wireless transmission unit each has a protective piece arranged on the outside, correspondingly connecting the engaging element.

6. The magnetic-controlled generator with built-in controller as claimed in claim 4, wherein the microprocessor is further connected to a transmission port for software to store the torque values from the training machine into the microprocessor for the control circuit unit to operate the adjusting process.

7. The magnetic-controlled generator with built-in controller as claimed in claim 1, wherein the magnetic ring is directly formed on the inner peripheral edge of the outer rim of the flywheel.
